(19) United States
(12) Patent Application Publication
(10) Pub. No.: US 2010/0287142 A1
(43) Pub. Date: Nov. 11, 2010

(54) ACCESSING, COMPRESSING, AND TRACKING MEDIA STORED IN AN OPTICAL DISC STORAGE SYSTEM

(75) Inventors: Jonathan M. Wesener, Fremont, CA (US); Steven Gaskill, Campbell, CA (US); Paul Popelka, Cupertino, CA (US)

Correspondence Address: FENWICK & WEST LLP, SILICON VALLEY CENTER, 801 CALIFORNIA STREET, MOUNTAIN VIEW, CA, 94041, US

(73) Assignee: PowerFile, Inc., Foster City, CA (US)

(21) Appl. No.: 12/776,213

(22) Filed: May 7, 2010

Related U.S. Application Data
(60) Provisional application No. 61/176,697, filed on May 8, 2009.

(51) Int. Cl. G06F 17/30; G06F 12/02

(52) U.S. Cl. 707/667; 711/103; 707/E17.007; 711/E12.008

(57) ABSTRACT

Methods, systems, and computer readable media are provided for accessing and compressing data stored in a media library, as well as tracking optical media with media tags and cartridge manifests within a library. In one embodiment, a simulation layer of a hybrid storage appliance allows libraries of optical media with write-once read-many (WORM) properties to look like logical block devices with non-WORM characteristics. In another embodiment, data from a user's files is compressed by the media library appliance in chunks in such a way that coarse granularity seeking is possible within a compressed user file. In another embodiment, a media cloud is used by a hybrid storage appliance to seamlessly recover from failures in optical media, library robotics, optical drives, and network connections during the creation, recovery, and distribution of data. In another embodiment, cartridge manifests and media tags are used to track optical media within a library.

### CROSS-REFERENCE TO RELATED APPLICATION

This application claims a benefit of, and priority under, 35 U.S.C. §119(e) to U.S. Provisional Patent Application Ser. No. 61/176,697, “Accessing, Compressing, And Tracking Media Stored In An Optical Disc Storage System,” filed on May 8, 2009, which is incorporated herein by reference in its entirety.

### BACKGROUND

1. Field of Art

This disclosure pertains in general to accessing media stored in an optical disc storage system, and specifically to a media library of a storage appliance.

2. Description of the Related Art

Because the consequences of data loss can be dire, methods of archiving data for long-term storage have been developed. Traditionally, there have been two choices for permanent storage: either data is kept online or it has been archived. Online data offers the advantages of rapid access in a searchable format. Archived data offers the advantage of being removable, providing longer-term storage, and freeing space on high-cost online storage subsystems, such as hard drives.

One alternative for storing data is to copy data onto tape for archiving. Tape is not designed to provide easy, immediate access to information. It is typically written in a proprietary backup format and can only be searched sequentially. It is designed for the infrequent and unlikely retrieval of backup data when primary storage fails. It is designed for density, not access. Besides the inaccessibility of tape, there is the risk of storing important archives on a medium not intended for permanence. Tape is used for periodically overwriting files, not for preserving valuable fixed content in a permanently etched, unalterable form. Unlike certain types of optical media, tape is not native write-once read-many (WORM) compliant, and tape is susceptible to environmental influences such as magnetic interference. As a result, tape is not well-suited for archiving high-value content.

### BRIEF DESCRIPTION OF THE DRAWINGS

FIG. (“FIG.”) 1 illustrates a software architecture of a hybrid storage appliance, in accordance with an embodiment.

FIG. 2 illustrates the operation of writing data using a hybrid storage appliance having a LUN layer, in accordance with an embodiment.

FIG. 3 illustrates the operation of reading data using a hybrid storage appliance having a LUN layer, in accordance with an embodiment.

FIG. 4 illustrates LUN block mapping, in accordance with an embodiment.

FIG. 5 illustrates an example of a conventional UDF layout.

FIG. 6 illustrates a modified UDF layout, in accordance with an embodiment.

FIG. 7 illustrates a method of generating an increment containing compressed files, in accordance with an embodiment.

FIG. 8 illustrates a method of accessing a compressed data from an archived file, in accordance with an embodiment.

FIG. 9 illustrates a cloud of optical media in accordance with an embodiment.

FIG. 10 illustrates a media tag and multiple cartridge manifests, in accordance with an embodiment.

FIG. 11 illustrates a method of creating a manifest in accordance with an embodiment.

### DETAILED DESCRIPTION

The figures (“FIGS.”) depict embodiments for purposes of illustration only. One skilled in the art will readily recognize from the following discussion that alternative embodiments of the structures and methods illustrated herein may be employed without departing from the principles described herein.

### Configuration Overview

Embodiments disclosed include methods, systems and computer readable media for accessing and compressing data stored in an optical media library. In one embodiment, a simulation layer of a hybrid storage appliance allows one or more libraries of optical media with WORM properties to look like one or more logical block devices with non-WORM characteristics. In another embodiment, data from a user's files is compressed by the media library appliance in chunks in such a way that coarse granularity seeking is possible within a compressed user file. In another embodiment, a media cloud is used by a hybrid storage appliance to seamlessly recover from failures in optical media, library robotics, optical drives and network connections during the creation, recovery, and distribution of data.

Other embodiments provide methods, systems, and computer readable media for tracking optical media with media tags and cartridge manifests within a library. A manifest attached to a media cartridge contains detailed information on each piece of media contained in the cartridge. In addition, each piece of media has an associated media tag that follows the piece of media around inside of the library. The media tag is stored, for example, in flash on the device where the piece of media resides, be it in a cartridge, a robotics sled, or in an optical disc drive.

### Simulation of a Logical Block Device

A simulation layer of a hybrid storage appliance (“HSA”) allows one or more libraries of optical media with WORM properties to appear to act like one or more logical block devices with non-WORM characteristics. In one embodiment, a direct-attached Logical Unit Number storage interface is provided for access to logical units of data on a HSA. FIG. 1 illustrates an example embodiment of a software architecture 1000 of a HSA.

The HSA functions as a data pipeline. One end of the pipe is accessed via client computers and the other end is optical media. In one embodiment, clients write data into the pipeline using the network file server (NFS) or common internet file server (CIFS) file sharing protocols. The network file server daemon (NFSD) and server message block daemon (SMBD) blocks handle the file serving protocols and read/write data from/to a cache file system represented by XFS. The cached data is stored on a hard disk. When files are created and altered XFS notifies a command and control daemon (CCD) of these attempts via a data migration application program interface (DMAPI). CCD can then decide to allow the access, deny the access, or delay the access until needed data is available. As files are created in XFS, CCD monitors the files until the files are no longer being changed. At this point, CCD marks the files as being immutable. Next, CCD adds the immutable files to an in-progress universal disk format (UDF) files system instance with a UDF image creator. The UDF image creator writes immutable files into a UDF file system image that is stored in a staging area. Once the UDF file system image is full, the UDF image creator directs a single board computer daemon (SBCD) to copy the UDF file system image to an optical disc. The SBCD uses robotics to move the appropriate optical disc into a drive and then performs the copy operation. Once data is stored on an optical disc, the copy of the data stored in the cache file system (XFS) can be purged, freeing up space in the cache.

In the future, an NFS or CIFS client may wish to access data which had been purged from the cache file system. When this happens, DMAPI notifies CCD that data that is not in the cache file system needs to be retrieved from an optical disc. CCD will then direct SBCD to load the appropriate optical disc into a drive, read the needed data, and send it back to CCD. CCD then writes the data back into the cache file system, and then informs XFS that the data it needs is again available. XFS then lets NFSD or SMBD return a copy of the data to the requesting client.

FIG. 1 illustrates three ways an optical disc storage system (ODSS) is accessed by the outside world, namely networking share, permanent storage space (PSS), and monitoring. In various embodiments, clients storing and retrieving data use networking share, administrators configuring an ODSS use the PSS, and administrator monitor the ODSS via the monitoring module.

The Jukebox manager (JBM) tracks where optical discs reside and whether they are in use or idle. When CCD needs to write to or read from an optical disc, it consults JBM to schedule access to the optical disc. Once JBM grants access, CCD can direct an SBCD to perform whatever access is needed. When the access is complete, JBM marks the involved optical disc as idle and schedules any other accessors waiting for that piece of media.

Also included in some embodiments of the HSA is a logical volume manager (LVM) and/or a redundant array of inexpensive discs (RAID). The ODSS uses LVM and/or RAID to gather physical disc drives and treat them as a larger logical disc drive with protection from loss of data caused by the failure of a single disc drive.

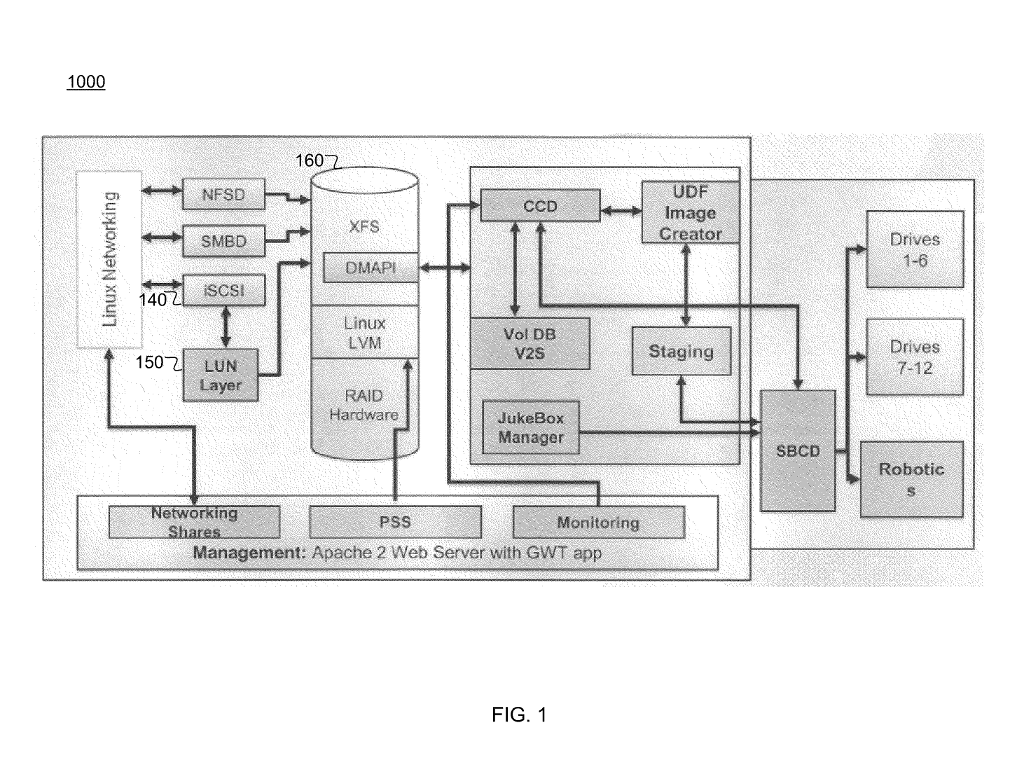

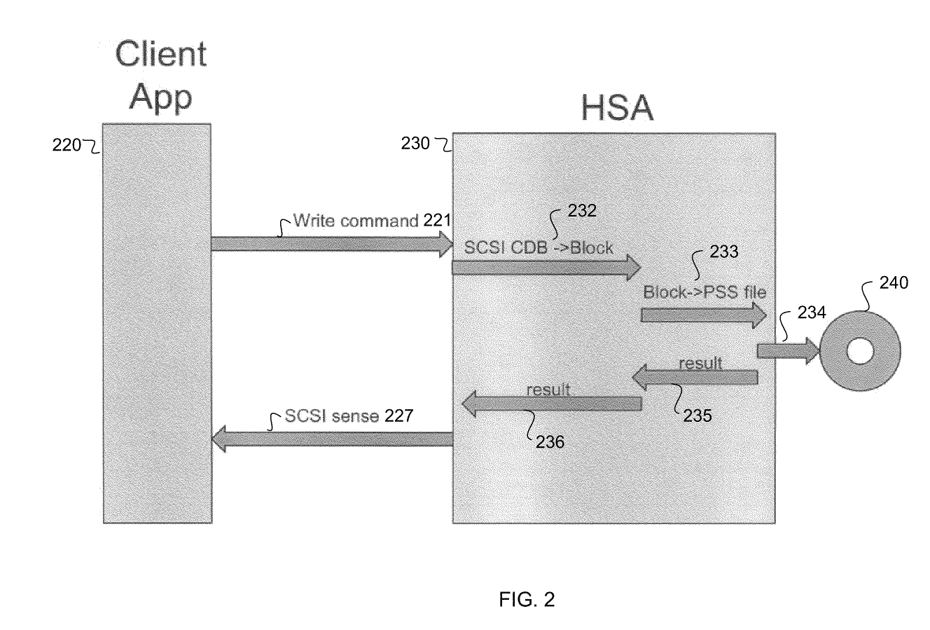

As FIG. 1 shows, the software architecture 1000 includes an Internet Small Computer Systems Interface (“iSCSI”) 140, a Logical Unit Number (“LUN”) layer 150, and an XFS file system 160. The interface 140 accepts standard disk block device SCSI commands, and communicates with a LUN layer 150 that sits on top of the XFS file system 160. The LUN layer 150 maps a LUN to a HSA Permanent Storage Space (“PSS”). Logical blocks in the LUN are mapped to files in the HSA PSS that can be accessed through the XFS file system 160. As a result, the iSCSI 140 makes the HSA look like a standard disk device, not like a tape device, to a client. Thus, files in the HSA PSS can be created, accessed, edited, and deleted as if they were stored on a standard disk device. FIGS. 2 and 3 illustrate the operations of writing data and reading data from the HSA having a LUN layer 150 in more detail.

FIG. 2 illustrates an example embodiment of the operation of writing data using a HSA 230 having a LUN layer 150. A client application 220 issues a write command 221, which is received by the HSA 230. The SCSI command descriptor block (“CDB”) maps 232 the write command to a data block. The block is mapped 233 to a PSS file, which ultimately is written 234 onto an optical media storage disc 240 within a media library. The resulting location of the PSS file is stored for future access. The status of the file system file creation and write is passed back 235 as a result of the file creation and write process. The result is mapped 236 into appropriate SCSI error and sense codes as defined by the standard SCSI specification for block device writes. The SCSI error and sense codes 227 are then communicated from the HSA 230 to the client application 220.

FIG. 3 illustrates an example embodiment of the operation of reading data using a HSA 230 having a LUN layer 150. A client application 220 issues a read command 331, which is received by the HSA 230. The SCSI CDB maps 332 the read command to the appropriate data block. The appropriate data block is then mapped 333 to the corresponding PSS file, which is ultimately read 334 from an optical media storage disc 240 within the media library. The status of the file read and the data read from the file are passed back 335 and mapped 336 into appropriate SCSI error and sense codes as defined by the standard specification for block device reads. The SCSI error and sense as well as the data 337 read from the file are then communicated from the HSA 230 to the client application 220.

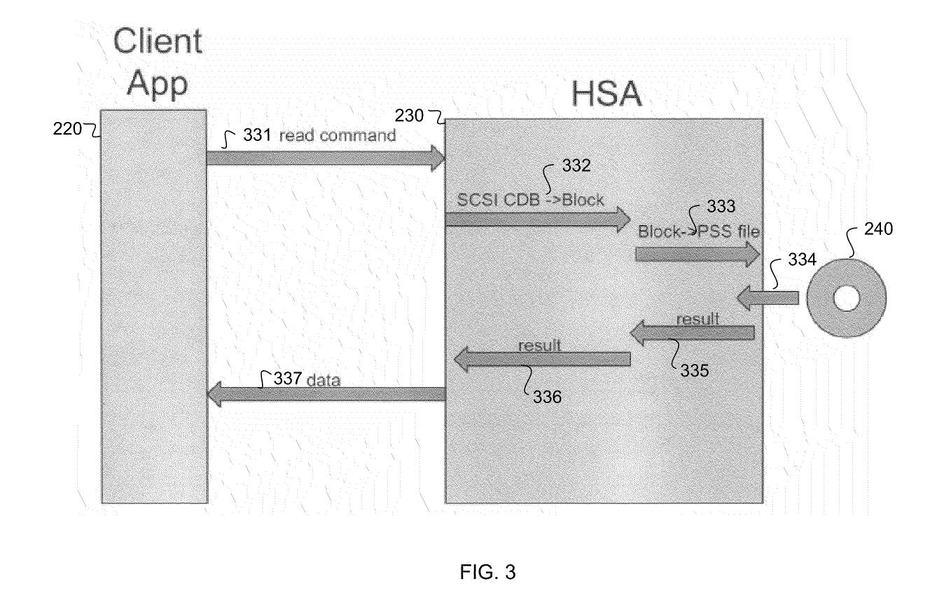

FIG. 4 illustrates an example embodiment of a LUN block mapping. The LUN layer 150 maps blocks to a HSA PSS. Thus, logical block requests are translated into XFS file accesses. In one embodiment, multiple sequential blocks are mapped to a single file. For example, as shown in FIG. 4, LBA 0 and LBA 1 have been mapped to a single XFS file “blk_{—}0_vers_{—}0”. Any modification or changes to the blocks are handled with file versioning. When a block changes, a new file with an incremented version is created, and the reference to the previous file/older version is deleted. Thus, if the data of LBA 1 changes, a new file “blk_{—}0_vers_{—}1” with the updated data is created, and the reference to the outdated file “blk_{—}0_vers_{—}0” is deleted. In one embodiment, the LUN layer 150 only accesses at the latest version of any file, thus accessing the newest, current version of the file. As a result, a library of optical media with WORM properties appears to a client application 220 as one or more logical block devices with non-WORM characteristics.

### File Compression

In one embodiment, user file contents are compressed as they are written into a Universal Disc Format (“UDF”) archive volume of a media library. A problem presented by file compression for UDF increment generation is that the size of the compressed file is unknown without actually compressing it. To compress a file, the contents must be read, and it is desirable to only read a file's contents once to generate an increment. Thus, in one embodiment, the act of compressing a file's contents puts the compressed data into the increment being generated. Another problem presented by compression is that it is not efficient to uncompress a large mass of data when a user wants to retrieve a small portion of the data from a large archived file. It is desirable to compress data in such a way that coarse granularity seeking is possible within a compressed user file.

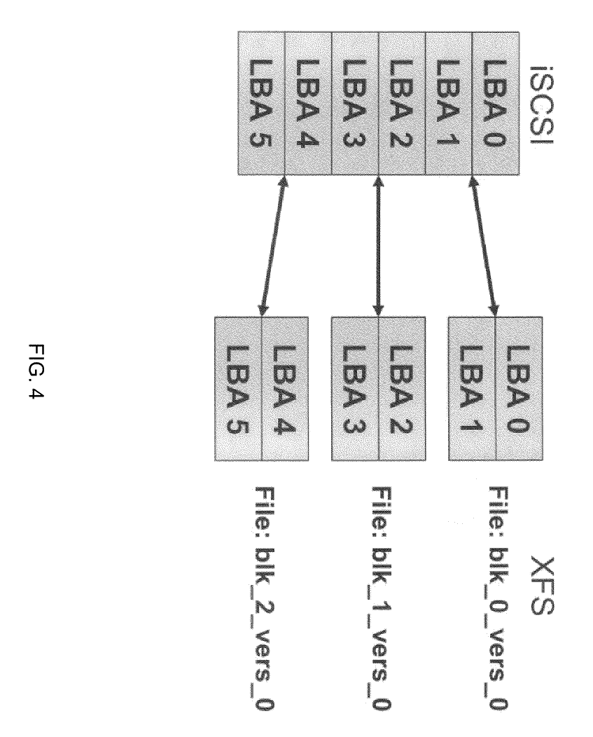

FIG. 5 illustrates an example of a conventional UDF layout. UDF is a standard that describes the format and arrangement of disc blocks within a UDF file system. The various blocks in FIG. 5 are areas defined by the UDF file system definition, which can be found in European Computer Manufacturers Association 167, also referred to as the ECMA-167 standard. In one embodiment, in addition to the standard UDF file system definition, the block referred to as error correction code (ECC) data stores the checksums of all data written into the UDF file system from the top of FIG. 5 up to the point where the ECC data begins. If blocks in the checksumed area are damaged such that the ECC used by the optical drive and media is not sufficient to recover data, the ECC is used to attempt another level of data recovery. As shown in FIG. 5, the file system metadata is written before the compressed user data.

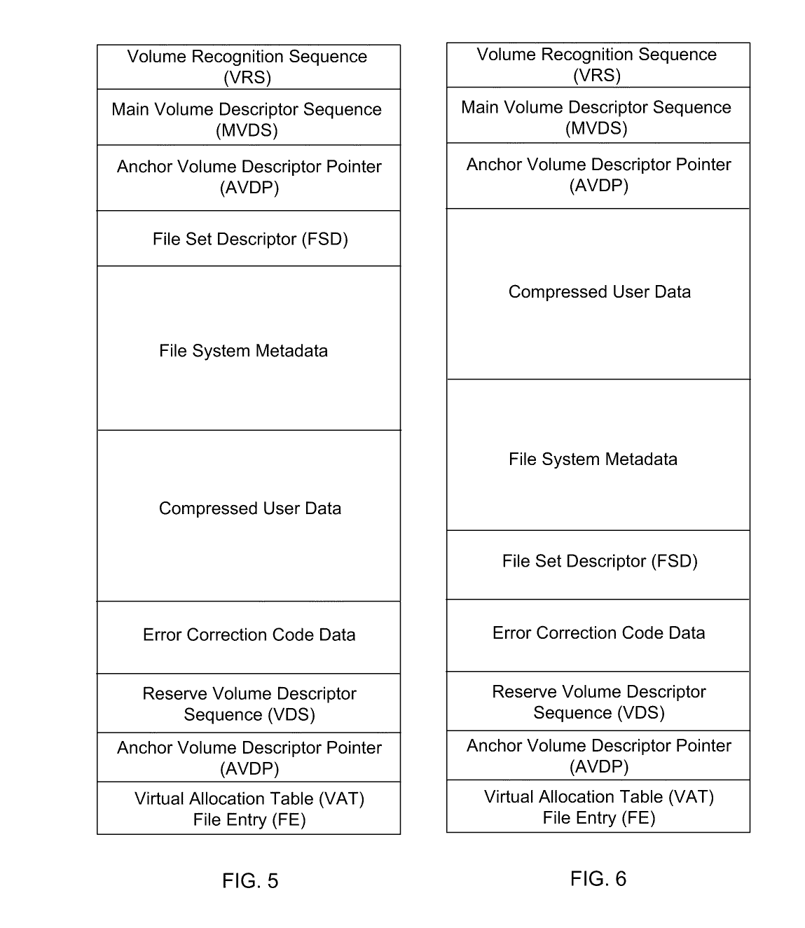

FIG. 6 illustrates a modified UDF layout, in accordance with an embodiment. In one embodiment, in the modified UDF layout, writing is performed as sequentially as possible starting from the top of FIG. 6. The contents of the file system metadata are determined by the sizes of the files placed in the user data area of the UDF file system. When compressing data, advanced knowledge of the compressed size is not available. Thus, to avoid compressing data twice, data is compressed into the user data area of the UDF file system and the compressed file size is obtained at the same time. Accordingly, the compressed user data is written into the UDF file system first in order to generate the file system metadata. As shown in FIG. 6, to allow the streaming of compressed data directly into a UDF file system increment, the location of the user data is moved to the start of the partition area of the increment. Following the compressed user data is the file system metadata.

Historically, the increment generation process was split into two phases. The first phase gathered metadata for frozen files, built the corresponding UDF metadata into an in-memory tree structure, and repeated these steps until the UDF increment being assembled was full. An increment was allowed to be resized once if a big file did not fit into the remaining space in an increment. Once the increment was full, disk space for an increment (e.g., an adequate number of sectors of disk space) was pre-allocated and the UDF increment was generated by synthesizing the UDF metadata, copying user file data into the increment, and writing the manufactured error correction code data into the increment.

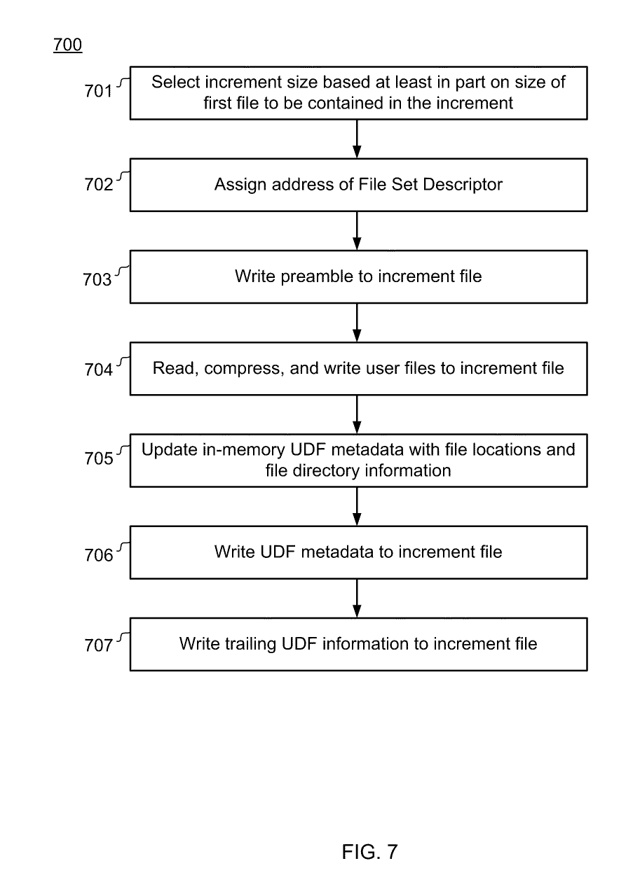

FIG. 7 illustrates a method 700 of generating an increment containing compressed files, in accordance with an embodiment. A change to the historical process of increment generation is that the increment's size is selected in step 701 based at least in part on the size of the first file going into the increment. If the first file is smaller than a desired increment size, the desired increment size is targeted as additional files are added. If the first file is larger than the desired increment size, the size of the increment is adjusted so that it can contain the file.

In step 702, with the increment size selected, the address of the File Set Descriptor that follows the compressed user data can be assigned. For example, the address of the File Set Descriptor can be the last two sectors in the increment that are protected by error correction code.

Once the increment size is fixed and space is allocated for the increment file, in step 703, the preamble to the user data is written to the UDF increment file. In one embodiment, the preamble includes the items in FIG. 6 above the compressed user data, including the volume recognition sequence, the main volume descriptor sequence, and the anchor volume descriptor pointer.

In step 704, the user files are read, compressed, and written to the UDF increment. While compressed files are written, in step 705, the in-memory UDF metadata is updated with the file's location and file directory information. In one embodiment, a compressed chunk directory for each file is created which is written into the UDF metadata. As files are added to an increment, there eventually comes a point where there is not enough room to hold the next file and its metadata. When there is not enough space left in the increment to accommodate the next file and its metadata, in step 706, the UDF metadata is written into the increment.

After the UDF metadata is written to the increment file, in step 707, the trailing UDF information is written. In one embodiment, the trailing UDF information includes the items in FIG. 6 below the file system metadata, including the file set descriptor, the error correction code data, the reserve volume descriptor sequence, the anchor volume descriptor pointer, and the virtual allocation table file entry. After the trailing UDF information is written, the increment is complete.

In one embodiment, files are compressed in chunks of a predetermined size, for example, 64 megabytes. In one embodiment, the 64 megabyte chunk is a preferred size because file contents are typically recalled in 64 megabyte chunks; however, it is noted that larger or smaller chunks sizes may be used. Compressing a user file involves reading 64 megabytes (or less) from the file, compressing that chunk into another buffer and then writing the compressed result into the UDF increment. This process is repeated until the file is completely in the increment. If an attempt to compress the chunk results in a chunk that is larger than 64 megabytes, the uncompressed data is written into the increment. Since the ultimate goal is to save sectors on archive media, compressing a file should result in saving at least one sector (2048 bytes, in one embodiment) of space in order to justify the compression. Otherwise, the data is archived in an uncompressed state.

Each 64 megabyte chunk of a file (compressed or not) will have a byte offset relative to the beginning of the file stored into a compressed chunk directory. Each file will have a compressed chunk directory, as described above with reference to step 705, that is stored, for example, in the file's UDF extended attributes. The compressed chunk directory is used during file recall to quickly locate any 64 megabyte chunk in a compressed archived file.

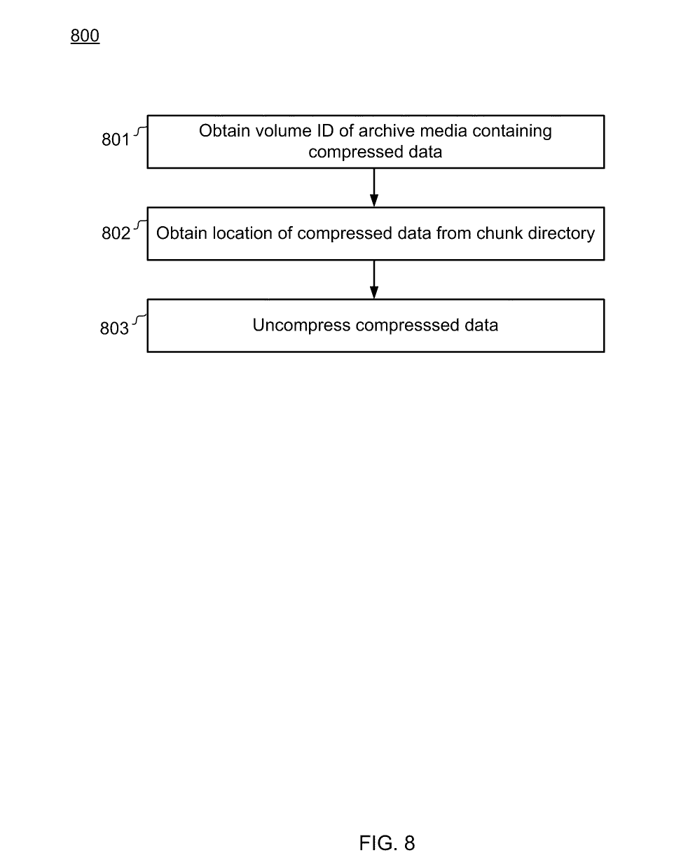

FIG. 8 illustrates a method 800 of accessing compressed data from an archived file, in accordance with an embodiment. In step 801, the volume ID of the archive media containing the compressed data from the archived file is obtained. In one embodiment, each archived file has a stub in the cache file system for the PSS containing the file. In one embodiment, a stub is a zero length file of the same name with extended attributes that have the information necessary to recover the file data from optical media. This information includes a list of volumes (burned optical discs) and for each volume a list of extents for the file. Each extent details a location on the optical media and its size.

With the addition of compression, knowledge of where compressed data desired to be recalled is located within the compressed data for the file is needed. In step 802, the location of the desired compressed data is obtained from the chunk directory. As described above, there is a compressed chunk directory in the UDF extended attributes for every compressed file. To allow the file recall code to get to the compressed chunk directory quickly, in one embodiment, the location of the chunk directory is stored in the cache file system extended attributes for the file. In one embodiment, a buffer is used to hold the compressed chunk directory. The recall process reads in the compressed chunk directory pointed to in the extended attributes. Then the archive sectors containing the compressed data can be identified.

In step 803, the compressed data in the identified sectors is uncompressed. Recalling the contents of an archived file requires that the contents of the file be uncompressed if they are compressed. A compressed file is detected by the presence of its compressed chunk directory. If there is no directory, the file is assumed to be uncompressed, in one embodiment. Since, in one embodiment, compression is performed in 64 megabyte chunks, two 64 megabyte buffers are used for file recall processing: one to contain the compressed data and one to hold the uncompressed data as it is uncompressed.

The above described processes for compressing user data and accessing compressed user data are compatible with and complimentary to many compression algorithms known in the art. In one embodiment, the LZO compression algorithms are used. The LZO compression algorithms are available from http://www.oberhumer.com/opensource/lzo.

Seamless Recovery from Media Cloud

The Hybrid Storage Appliance (“HSA”) provides online archival access to very large collections of files. In on embodiment, files are distributed in various forms in a cloud of optical media. The cloud refers to all optical media stored in libraries locally attached or remotely connected to the HSA via WAN/LAN or a sister HSA. The nature of the underlying optical media does not allow for the use of traditional technologies for redundancy and automatic error recovery. Traditional file systems are backed by block devices which allow for various levels of RAID such as mirroring and parity drives. The HSA is backed by file based optical media so different techniques are used to seamlessly recover from failures in optical media, library robotics, optical drives, and network connections for the creation, recovery, and distribution of data across the libraries and optical media.

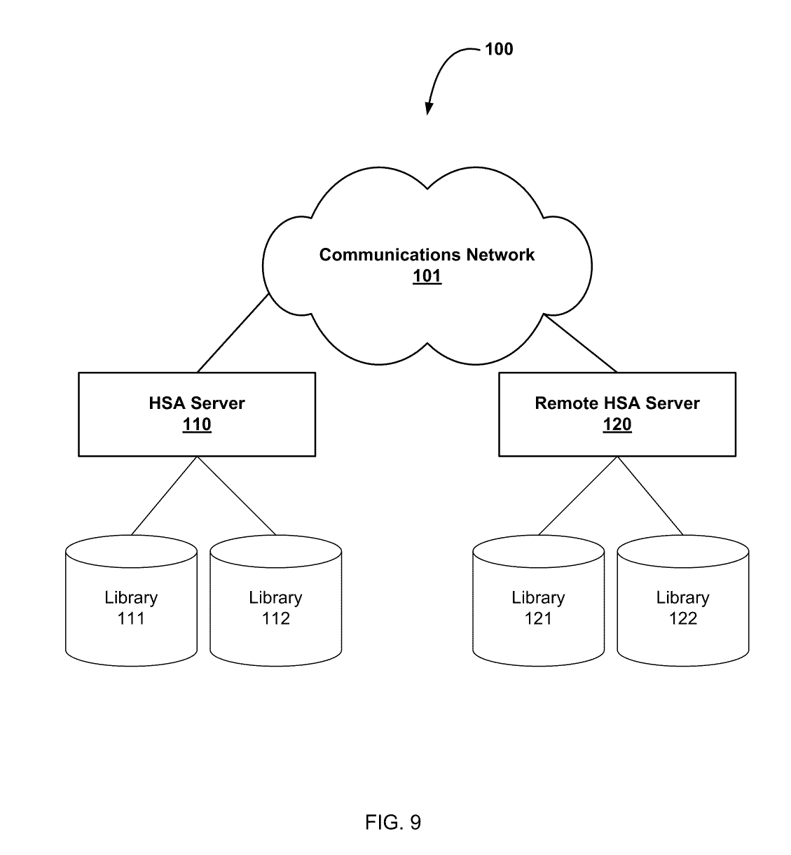

FIG. 9 illustrates one embodiment of a cloud 100 of optical media. The media cloud 100 encompasses multiple libraries that are local as well as libraries that are remotely connected via a sister HSA. As shown in FIG. 9, the cloud 100 includes a HSA server 110 with locally attached libraries 111 and 112, as well as a remote HSA server 120 with its attached libraries 121 and 122. The remote HSA server 120 is connected to the HSA server 110 through a communications network 101. In one embodiment, the communications network 101 is a WAN or a LAN, but in other embodiments, the communications network is an intranet or the Internet. In one embodiment, as problems develop in one part of the cloud 100, requests are routed via the communications network 101 to other parts of the cloud 100 to be fulfilled.

For file storage, files first show up on the server in the front-end file system cache. The files go through a waiting period before they freeze and are marked eligible for migration to optical media. An increment is created containing one, or a portion of one, or more than one file, for example, as described above with reference to FIG. 7. When the increment is ready, a library, a piece of media, and an optical drive are selected to burn the increment. A piece of media can contain one or more increments. An increment can be burned to more than one piece of media for redundancy. The media can then be located anywhere in the media cloud 100.

Once the file has been placed in an increment, the file is removed from the system and a stub is left that will trigger a file recovery to the front-end cache the next time the file is accessed. As described above, in one embodiment, a stub is a zero length file of the same name with extended attributes that have the information necessary to recover the file data from optical media. This information includes a list of volumes (burned optical discs) and for each volume a list of extents for the file. Each extent details a location on the optical media and its size.

If a failure occurs during the burn process, a new combination of library, media, and optical drive are picked and the process continues until one or more copies of the increment have been created. In one embodiment, the final location of the data in the media cloud 100 is typically not known by a user of the HSA server 110.

A file is recovered from the media cloud 100 when a request is made to access the file through the front-end file system cache. The file stub access triggers a request to be made to the media cloud 100. A piece of media containing the file is chosen based upon resource availability. If the file exists on a single piece of media, then the decision is simply when to schedule loading the piece of media into an available drive. If the media exists in multiple locations in the cloud 100, the decision is based on a preference for local libraries 111 and 112 over remote libraries 121 and 122 and then on library and/or drive availability within the library.

If a failure occurs while trying to access this piece of media, the cloud automatically chooses a new combination of library, drive, and optical media. In one embodiment, the self-healing media cloud 100 has the following properties:
A failed request will start where the previous request left off. If data was pulled from the previous media combination, it will be used and not re-read from the current media combination. This saves time and conserves processing resources.
If a drive fails, the media will be moved to a different drive within the same library.
If a library fails, the request will be forwarded to another library containing a copy of media.
If the media fails (e.g., the disc goes bad) a different copy of the media will be used. The failed piece of media will be invalidated and a new copy of the media may be created to replace it.

When data arrives in the server's front-end cache, the data is sent back to the original requester of the data. The end user need not be notified or even aware of how the user's request was fulfilled by the media cloud 100. After some period of inactivity, the contents of the file are purged from the front-end cache and again replaced with the stub. In one embodiment, no data is written to optical media during this purge.

The media cloud 100 provides an automatic fail over for the creation, recovery, and distribution of data across the libraries and optical media. The media cloud 100 can recover from failures in libraries, drives, and optical media, and the media cloud's activities may be transparent to the end-user of the HSA.

### Tracking Media in a Library Via Media Tags and Manifests

In one embodiment, the Hybrid Storage Appliance (HSA) supports 500 pieces of media in a library. This media is moved between 514 locations within the library, including storage cartridges, disc transfer assemblies, and media drives. Optical media normally resides in small (e.g., 25 slots) or bulk (e.g., 225 slots) cartridges that are frequently moved in and out of the libraries. Since loading and reading the contents of each disc can take well over 2 hours depending upon the configuration, a mechanism is used to track the location of each disc in the library along with a summary of the disc's contents. This information also follows the discs around in the cartridge as the cartridges are moved in and out of libraries.

A manifest is created per cartridge that has detailed information on each piece of media it contains. This manifest is maintained, for example, in a flash device physically attached to the body of the media cartridge, in one embodiment. Alternative storage mechanisms or memory devices can also be used. In one implementation, flash devices are also attached to optical drives within the library and the body of a robotics sled used to transport the media between slots of a cartridge and the optical drives. Each piece of media has an associated media tag that follows the piece of media around inside the library. Media can reside in a cartridge, a robotics sled, or in an optical drive. The media tag is stored in flash or other storage medium on the device where the piece of media currently resides, be it a cartridge, robotics sled, or an optical disc drive.

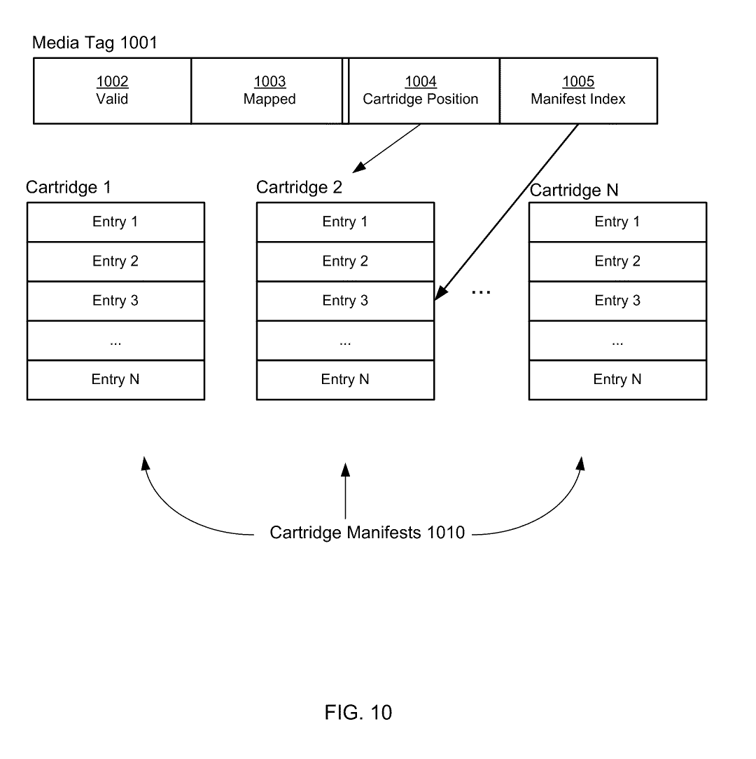

FIG. 10 illustrates a media tag 1001 and multiple cartridge manifests 1010, in accordance with an embodiment. In this example, the media tag 1001 contains information indicating whether the media tag is valid, information indicating whether the media tag is mapped to a cartridge manifest 1010 entry, a indicator of the cartridge position 1004 that has the cartridge manifest 101 that contains a manifest entry having detailed information about the media associated with the media tag 1001, and an index 1005 to the cartridge manifest that points to the location in the manifest where the entry having detailed information about the media associated with the media tag 1001 can be found. The cartridge manifests 1010 contain an entry corresponding to each piece of media in the respective cartridge. In one embodiment, the manifest entry is not tied to a particular slot in the cartridge, but instead is associated to the media with the media tag.

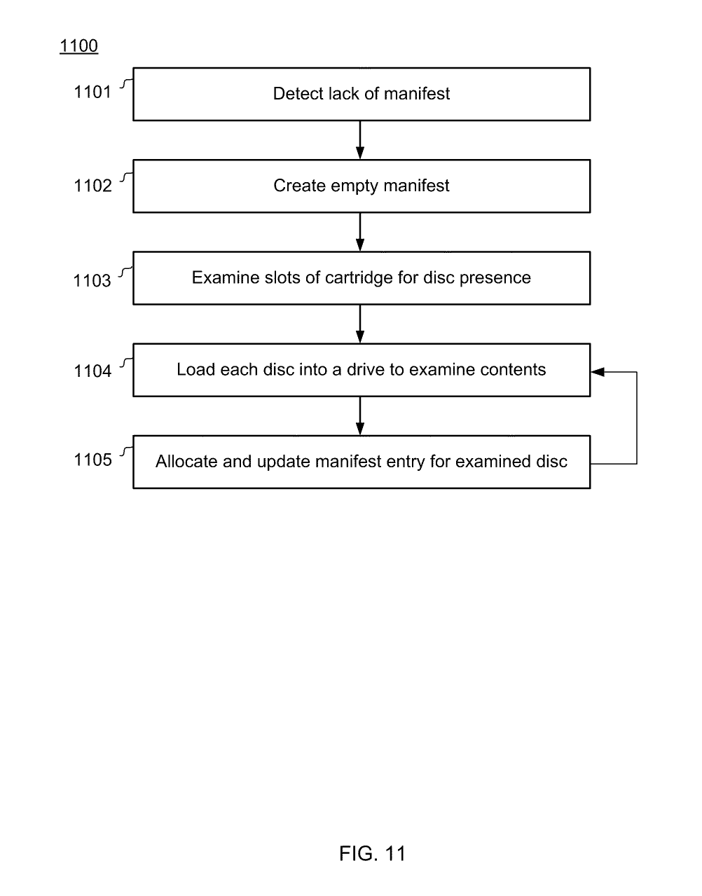

FIG. 11 illustrates a method of creating a manifest 1010 in accordance with an embodiment. A cartridge starts out in a library in an uninitialized state. In step 1101, the lack of a manifest and media tags is detected for an uninitialized cartridge. In step 1102, an empty manifest 1010 for the uninitialized cartridge is created and stored, for example, in a flash device attached to the cartridge. In step 1103, an examination is then made of each slot in a cartridge to see if it contains a disc. Full slots are given a valid 1002 tag and left unmapped. This indicates to the library that it is known that there is media present in the slot but that it is not yet inspected. In step 1104, each piece of media that is not yet inspected is loaded into a drive and examined to determine its contents. Then, in step 1105, when the examined disc is moved back from the drive to the cartridge, a manifest entry in the cartridge manifest 1010 is allocated and updated. Steps 1104 and 1105 are repeated until all discs have an updated manifest entry. The location of the manifest entry is used to create a new “mapped” 1003 media tag and the media tag 1001 for that piece of media is updated.

When the library starts up, in one implementation, the library performs an inventory of all the media present in the library. This inventory is created from the contents of the various flash devices on cartridges, robotic sleds, and drives. For cartridges, the manifest entries 1010 and media tags 1001 reside in the cartridge flash so that the cartridges can be removed and replaced in libraries and still provide instant access to the inventory. As a result of the inventory, the library is presented with a map indicating the locations of media along with the associated media tags 1001. If a piece of media has a media tag 1001, the corresponding manifest entry is retrieved from the cartridge flash. This initial inventory process occurs very quickly and avoids the need to load discs into drives or for discs to be registered to a particular location.

In one embodiment, during normal operation, the manifest entry is only modified following an operation performed while the disc is in the drive (e.g., data written to the media). However, loading a disc into a drive merely to read its contents would not change the manifest contents. After an operation is performed on the disc while the disc is in the drive, the current state of the media is compared to the recorded state of the media in the manifest 1010 as it is unloaded. If the states differ, the manifest 1010 is updated to reflect the current state. As discussed above, the manifest entry is not tied to a particular slot in the cartridge, but instead the manifest entry is associated to the media with the media tag 1001. This allows the media to be moved around at will within the cartridge, robotics sled and optical disc drive without changing the manifest entry.

In one embodiment, during normal operation, the media tag 1001 remains unchanged, except for the following situations:
When a new disc appears in a slot. As described above, when a new disc is added to a cartridge, the media tag 1001 is set to valid 1002 with no mapping 1003.
When a new disc is first inspected and assigned a manifest entry. The media tag 1001 is set to include and indicate a mapping 1003 to a cartridge manifest 1010 entry. The cartridge position 1004 and the manifest index 1005 for the media tag 1001 can also be updated at this time.
When a disc is moved from one cartridge to another. The manifest entry is copied from the source cartridge to the destination cartridge. The source manifest entry is freed up. The media tag 1001 is modified to indicate the cartridge position 1004 of the destination cartridge and the new location in the manifest index 1005 of the manifest entry in the destination cartridge.
When a cartridge is replaced in a library. The media tag 1001 tracks the parent cartridge based on its position 1004 in the library. Since the cartridge position can change when moved in and out of a library, the media tag 1001 may start out pointing to the wrong cartridge position. When the library first inventories a cartridge, in one embodiment, the library checks to make sure the media tags 1001 refer to the correct cartridge position 1004. If they do not, then the media tags 1001 are updated to reflect the new cartridge position 1004 in the library. Thus, the movement of a cartridge to a new position within a library has no significant impact on the inventory.

Because the media tag 1001 remains unchanged during normal operations, except in certain circumstances detailed above, the frequency of updating the media tags 1001 and the manifest is manageable. Thus, the media tags and cartridge manifests provide a convenient mechanism to track the media in a library as the media are moved into, throughout, and out of the library.

### Other Configuration Considerations

The above description is included to illustrate the operation of embodiments and is not meant to limit the scope of the disclosure. From the above discussion, many variations will be apparent to one skilled in the relevant art that would yet be encompassed by the spirit and scope as set forth herein. Those of skill in the art will also appreciate other embodiments from the teachings herein. The particular naming of the components, capitalization of terms, the attributes, data structures, or any other programming or structural aspect is not mandatory or significant, and the mechanisms that implement the features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

The methods and operations presented herein are not inherently related to any particular computer or other apparatus. The required structure for a variety of these systems will be apparent to those of skill in the art, along with equivalent variations. In addition, the disclosure herein is not described with reference to any particular programming language. It is appreciated that a variety of programming languages may be used to implement the teachings as described herein, and any references to specific languages are provided for enablement and best mode of embodiments as disclosed.

Embodiments disclosed are well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope.

What is claimed is:

1. A method of simulating a logical block device with non-write once, read many (WORM) characteristics using a library of optical media having WORM characteristics, the method comprising:
providing a logical unit number layer that receives small computer systems interface (SCSI) protocol commands and maps the commands that reference a logical block to a current version of a file containing the logical block, the file stored in the library of optical media having WORM characteristics;
receiving a modification to the logical block;
creating a new file containing the modified logical block, the new file being an incremented version, wherein the incremented version becomes the current version of the file; and
storing the new file in the library of optical media.

2. The method of claim 1, further comprising deleting a reference to a previous version of the file.

3. The method of claim 1, wherein the file is an XFS file.

4. The method of claim 1, wherein a file contains multiple sequential logical blocks.

5. A method of compressing data for archival storage comprising:
selecting an increment size based at least in part on a size of a first file to be contained in an increment;
compressing files of data into chunks;
writing compressed chunks to the increment;
updating in-memory metadata with compressed user file locations and file directory information; and
writing the metadata to the increment.

6. The method of claim 5, wherein selecting an increment size based at least in part on a size of the first file comprises:
responsive to the first file being larger than a desired increment size, increasing the size of the increment to contain the file.

7. The method of claim 5, wherein the file directory information comprises a compressed chunk directory for each file in the increment, wherein a byte offset relative to a beginning of the file is stored in the respective compressed chunk directory.

8. A method of recovering data from a media cloud comprising:
receiving a file of data at a front-end file system cache;
storing the file in an increment on at least one piece of optical media;
removing the file from a front-end file system cache;
storing a stub for the file in the front-end file system cache, the stub comprising a file having the same name as the stored file and having extended attributes that identify one or more storage locations of the stored file on optical media;
receiving a request though the front-end file system cache to access the stored file; and
accessing the stored file from a storage location on optical media identified by the stub.

9. The method of claim 8, wherein the extended attributes identify a plurality of storage locations of the stored file on optical media, and wherein accessing the stored file from a storage location on optical media comprises:
reading a first portion of the stored file from a first combination of a storage library, an item of optical media, and an optical drive; and
responsive to a failure of the first combination to read a second portion of the stored file, reading the second portion of the stored file from a second combination of a storage library, an item of optical media, and an optical drive, wherein the second combination is different from the first combination, and wherein the second combination does not read the first portion of the stored file that was read by the first combination.

10. The method of claim 8, wherein accessing the stored file from a storage location on optical media identified by the stub comprises:
selecting a first combination of a storage library, an item of optical media, and an optical drive to read the stored file; and
responsive to a failure of the optical drive that prevents completion the reading, moving the item of optical media to another optical drive within the storage library to complete the reading.

11. The method of claim 8, wherein the extended attributes identify a plurality of storage locations of the stored file on optical media, wherein accessing the stored file from a storage location on optical media identified by the stub comprises:
selecting a first combination of a storage library, an item of optical media, and an optical drive to read the stored file; and
responsive to a failure of the storage library that prevents completion of the reading, accessing the stored file from another storage location of the stored file on optical media in a different library.

12. The method of claim 8, further comprising:
delivering the stored file responsive to the request; and
purging the stored file from the front-end file system cache and replacing the stored file with the stub.

13. A method of managing a manifest for a cartridge containing a plurality of pieces of optical media in a optical media library storage appliance, the method comprising:
for each piece of optical media in the cartridge, creating a manifest entry having detailed information about contents of the optical media, each piece of optical media associated with a media tag mapped to the respective manifest entry;
responsive to a piece of optical media being unloaded from a drive, comparing a current state of the optical media to a recorded state of the optical media in the respective manifest entry identified by the media tag; and
responsive to the current state differing from the recorded state, updating the respective manifest entry to reflect the current state.

14. The method of claim 13, wherein the manifest entries are stored in a flash device on the cartridge.

15. The method of claim 13, wherein the optical media library storage appliance comprises at least one cartridge, at least one disc transfer assembly, and at least one media drive, and wherein each cartridge, disc transfer assembly, and media drive includes a memory device, wherein the memory device stores a media tag associated with each piece of optical media currently residing in the cartridge, disc transfer assembly, or media drive.

16. The method of claim 13, further comprising:
responsive to the insertion of a cartridge into the optical media library storage appliance, performing an inventory of the contents of the cartridge by accessing the manifest.

17. The method of claim 13, further comprising:
responsive to a piece of optical media being moved to a destination cartridge from a source cartridge, deleting the manifest entry for the piece of optical media in the manifest of the source cartridge.

18. The method of claim 13, wherein the media tag comprises an indication of a cartridge position corresponding to the cartridge having the manifest entry of the piece of optical media.

19. The method claim 18, wherein responsive to a cartridge being removed from a first cartridge position in the optical media library storage appliance and inserted into a second cartridge position, updating the indication of cartridge position in the media tag of each piece of optical media for which the cartridge has a manifest entry.
